(19) United States
(12) Patent Application Publication
(10) Pub. No.: US 2022/0177200 A1
(43) Pub. Date: Jun. 9, 2022

(54) Roasting Stick Protecting Case

(71) Applicant: Robbie Franklin, Cynthiana, IN (US)

(72) Inventor: Robbie Franklin, Cynthiana, IN (US)

(21) Appl. No.: 17/539,569

(22) Filed: Dec. 1, 2021

Related U.S. Application Data
(60) Provisional application No. 63/120,866, filed on Dec. 3, 2020.

(51) Int. Cl. B65D 43/16; A45F 3/00

(52) U.S. Cl. CPC B65D 43/162; A47J 37/04; A45F 2003/003; A45F 3/00

(57) ABSTRACT

The present invention relates to a storage case for prongs of a roasting stick. The storage case is a cuboidal-shaped box having a main body and a lid. The lid is pivotally-connected to the main body and is designed to cover the main body. The main body includes a base and four walls extending from the base for storing the prongs of a roasting stick. One wall of the main body includes a semi-circular cut-out for accommodating the handle of the roasting stick, whose prongs are stored in the main body. One of the walls of the lid also includes a semi-circular cut-out that abuts or aligns with the semi-circular cut-out of the main body to form a circular opening through which the handle of the stick extends. The lid and the main body are latched together to securely store the prongs.

### CROSS-REFERENCE TO RELATED APPLICATION

The present application claims priority to, and the benefit of, U.S. Provisional Application No. 63/120,866, which was filed on Dec. 3, 2020 and is incorporated herein by reference in its entirety.

### FIELD OF THE INVENTION

The present invention relates generally to the field of storage cases. More specifically, the present invention relates to a modified storage case for roasting sticks that offers a safe, secure, and convenient storage and transportation method for roasting sticks. The case includes a main body for storing prongs of a roasting stick securely wherein the case is covered by a lid. The main body and the lid are secured using a latching mechanism. Both the main body and the lid have four walls and one wall of both the main body and the lid includes a semi-circular cut-out that is used for accommodating the connecting portion and shaft of the stick. The shaft extending from the cut-out can be used by a user for transporting the roasting stick. The prongs are safely covered to prevent black char and debris from contaminating a vehicle or the hands while storing and transporting the sticks. The covered prongs also provide protection from inadvertent poking or stabbing. Accordingly, the present disclosure makes specific reference thereto. Nonetheless, it is to be appreciated that aspects of the present invention are also equally applicable to other applications, devices and methods of manufacture.

### BACKGROUND

By way of background, individuals enjoy campfires and bonfires for recreational purposes. Individuals enjoy them in their backyard, near the river, at an outing or many other places. A popular tradition followed by individuals sitting around a fire is the toasting or roasting of marshmallows, hot dogs, or other roasting foods over the fire or other source of an open flame. The food item is typically placed on the prongs of a roasting stick and held over the flame until it turns golden brown or is cooked to a user's desire. Individuals generally grease the prongs by using butter or any other greasing or non-stick material. The butter or grease, along with the flame, together leave a greasy and sticky residue on the prongs, which is hard to clean. The prongs become sticky and dirty with black char and other debris. After use, individuals store these used roasted sticks in a vehicle or in a camper which leads to contamination of the vehicle or the hands while storing and transporting the used sticks. Individuals may need to spend time on cleaning roasting sticks before storing them, which is not only time-consuming but is also frustrating, embarrassing and messy. Individuals desire a solution to carry the used roasting sticks that not only safely transports them but eliminates the need to clean them before storage and transportation.

Prongs of the roasting sticks are sharp and can cause damage to an RV, camping gear, or even individuals when not in use and during transportation and storage. Even when the prongs are clean, individuals desire a safe and secure storage and transportation system.

Therefore, there is a long felt need in the art for a roasting stick storage device that securely and safely stores the prongs of a used roasting stick. Additionally, there is a long felt need in the art for a marshmallow roasting stick storage case that eliminates the need to clean the greasy and sticky prongs before storing the sticks for storage and transportation. Moreover, there is a long felt need in the art for a storage case that safely covers prongs of a stick to prevent black char and debris from contaminating a vehicle or the hands while storing and transporting the sticks. Further, there is a long felt need in the art for a storage case that protects RV, camping gear, and individuals from dirty prongs. Furthermore, there is a long felt need in the art for a storage case that can be used with any conventional roasting stick having prongs. Finally, there is a long felt need in the art for a unique storage case that offers a safe, secure and convenient storage and transportation method for roasting sticks.

The subject matter disclosed and claimed herein, in one embodiment thereof, comprises a protective storage case for storing and covering roasting stick prongs to prevent black char and debris from contaminating a vehicle or the hands while storing and transporting the sticks and to protect prongs from physical damage. The storage case features a main body and a lid. The main body includes a base with four walls extending vertically from the base for storing and shielding prongs of a roasting stick, a first semi-circular cut-out on one of the four walls of the main body, the lid having four walls symmetrical to the four walls of the main body, the lid is hingedly-coupled to the main body along a wall, thereby enabling a pivotal movement of the lid to cover the main body, a wall of the lid having a second semi-circular cut-out that combines with the first semi-circular cut-out to form a circular opening when the lid covers the main body and wherein the circular opening is used for extending the shaft of the roasting stick from the main body when the prongs are stored in the main body.

In this manner, the roasting stick storage case of the present invention accomplishes all of the foregoing objectives and provides a relatively safe, convenient, lightweight, etc., secure storage case for storing prongs of a roasting stick. The case protects the prongs from physical damage and protects users from injury due to the prongs. The case can store both clean and sticky prongs. The shaft extending from the case enables the user to carry the roasting stick and storage case using the handle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a protective storage case for roasting stick prongs. The protective storage case is configured to cover roasting stick prongs to prevent black char and debris from contaminating a vehicle or the hands while storing and transporting the sticks, and to protect the prongs from physical damage. The storage case further comprising a main body and a lid. The main body having a base with four walls extending vertically from the base for storing prongs of a roasting stick, a first semi-circular cut-out on one of the four walls of the main body, the lid having four walls symmetrical to the four walls of the main body, the lid is hingedly-coupled to the main body along a wall enabling a pivot movement of the lid to cover the main body, a wall of the lid having a second semi-circular cut-out that combines with the first semi-circular cut-out to form a circular opening when the lid covers the main body and wherein the circular opening is used for extending the shaft of the roasting stick from the main body when the prongs are stored in the main body.

In a further embodiment of the present invention, a wall of main body includes a latch base and the corresponding wall of the lid includes a latch head wherein the latch base and the latch head are used for fastening the main body and the lid to safely cover the prongs therein.

In a further embodiment of the present invention, a storage case for roasting sticks is disclosed. The storage case includes a rectangular main body and a lid for covering the main body. The main body is used for storing and shielding the prongs of a roasting stick and the prongs are safely covered by the lid by covering the main body. One of the walls of both the main body and the lid includes a semi-circle that forms a circular opening when the lid covers the main body, and is used for engaging the shaft of the roasting stick whose prongs are stored in the main body.

In a further embodiment of the present invention, one of the remaining walls of both the main body and the lid includes a latch mechanism for securing the lid to the main body.

In yet another embodiment, the latch mechanism configured for selectively providing access to the prongs stored in the main body when the latch mechanism is in an opened position thereby opening the lid, and configured for closing the main body when the latch mechanism is in a closed position whereby the lid covers the main body.

In yet another embodiment of the present invention, the prongs of a used roasting stick are safely covered by the storage case to prevent black char and debris stuck to the used prongs from contaminating a vehicle or the hands of a user while storing and transporting the sticks. Further, the storage case prevents prongs from physical damage during storage and transportation, and protects individuals from injury during the transportation.

In yet another embodiment of the present invention, a cuboidal protective box for roasting sticks is disclosed. The box includes a cuboidal design having a main body and a cover or lid. The main body includes two pairs of opposing walls and the lid also includes two pairs of opposing walls, each wall of the lid abuts with the corresponding wall of the main body when the lid covers the main body to protect the prongs of a roasting stick wherein the prongs are stored in the main body and the shaft of the roasting stick extends out from a circular opening formed by the semi-circular cut-outs on one wall of both the main body and the lid.

One advantage of the storage case of the present invention is that it securely stores both used and unused prongs of roasting sticks. The case eliminates black char and debris stuck to the prongs of a used roasting stick from contaminating a vehicle or the hands while storing and transporting the sticks. The storage case offers a safe, secure and convenient storage and transportation method for roasting sticks while the handle of the stick remains accessible for convenient grasping of each roasting stick.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a perspective view of one potential embodiment of the roasting stick prongs storage case of the present invention in an open position in accordance with the disclosed architecture;

FIG. 1B illustrates a perspective view of one potential embodiment of the roasting stick prongs storage case of the present invention in a closed position in accordance with the disclosed architecture;

FIG. 2 illustrates a perspective view showing prongs of an exemplary roasting stick stored in one potential embodiment of the storage case of the present invention in accordance with the disclosed architecture;

FIG. 3 illustrates a perspective view showing prongs of the exemplary roasting stick safely covered and shielded in one potential embodiment of the storage case of the present invention in accordance with the disclosed architecture;

FIG. 4 illustrates a perspective view showing roasting sticks stored using one potential embodiment of the protective storage case of the present invention in a vehicle trunk in accordance with the disclosed architecture; and

FIG. 5 illustrates a flow chart showing exemplary steps for use of one potential embodiment of the roasting sticks storage case of the present invention for storing prongs in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a roasting stick storage device that securely and safely stores the prongs of a used roasting stick. Additionally, there is a long felt need in the art for a marshmallow roasting stick storage case that eliminates the need to clean the greasy and sticky prongs before storing the sticks for storage and transportation. Moreover, there is a long felt need in the art for a storage case that safely covers the prongs of a stick to prevent black char and debris from contaminating a vehicle or the hands of a user while storing and transporting the sticks. Further, there is a long felt need in the art for a storage case that protects an RV, camping gear, and individuals from dirty prongs. Furthermore, there is a long felt need in the art for a storage case that can be used with any conventional roasting stick having prongs. Finally, there is a long felt need in the art for a unique storage case that offers a safe, secure, and convenient storage and transportation method for roasting sticks.

The present invention, in one potential embodiment, provides a novel cuboidal protective box for roasting sticks. The protective box comprises a main body and a cover. The main body includes two pairs of opposing walls, and the lid also includes two pairs of opposing walls, each wall of the lid abuts with the corresponding wall of the main body when the lid covers the main body to protect the prongs of a roasting stick. The prongs can be stored in the main body and the shaft of the roasting stick can extend outwardly from a circular opening formed by the semi-circular cut-outs on one wall of both the main body and the lid.

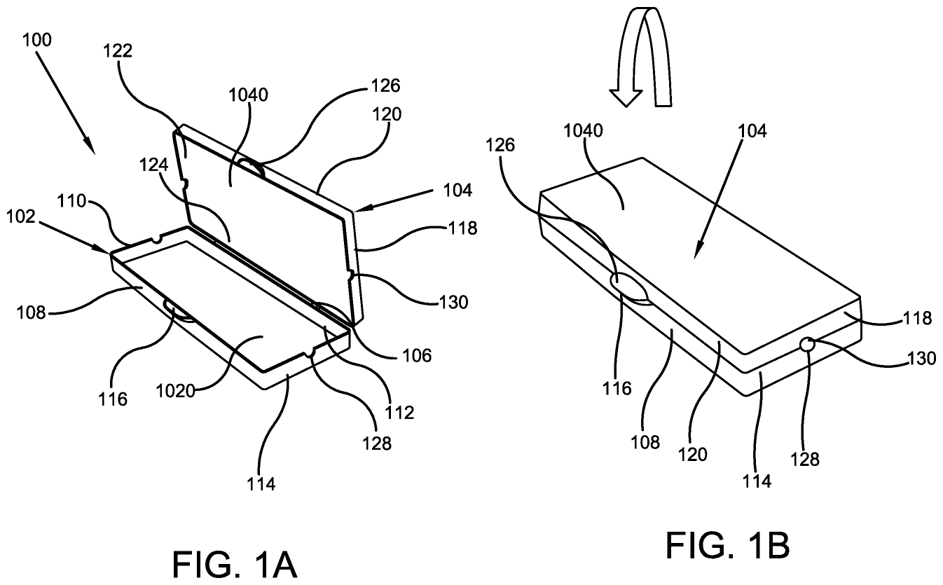

Referring initially to the drawings, FIG. 1A illustrates a perspective view of one potential embodiment of the roasting stick prongs storage case of the present invention in an open position in accordance with the disclosed architecture. The roasting prongs storage case 100 is a modified storage case designed to cover roasting stick prongs. The prongs, after use, can be safely secured and covered in the case 100 to prevent black char and debris from contaminating a vehicle or the hands of a user while storing and transporting the sticks. More specifically, the storage case 100 is a cuboidal-shaped case having a main body 102 and a lid 104. The main body 102 is used for receiving, storing, and shielding the prongs and is covered by the lid 104 for covering the stored prongs. The lid 104 is hinged to the main body 102 along a hinge 106 which enables pivoting movement of the lid 104 to cover the main body 102. The lid 104 is made symmetrical and is dimensioned as per the size of the main body 102 such that the lid 104 completely covers the main body 102. The main body 102 features four walls extending vertically from the base 1020 for creating a cavity that can be used for storing the prongs and the walls, and also protect the prongs from lateral movement. The walls 108, 110, 112, 114 extend vertically from the edges of the base 1020 with a first pair of opposing walls 108, 112 being longer in length than the second pair of opposing walls 110, 114. The lid 104 also includes a first pair of walls 120, 124 corresponding and symmetrical to the first pair of opposing walls 108, 112 of the main body 102 and a second pair of walls 118, 122 corresponding and symmetrical to the second pair of opposing walls 114, 110 of the main body 102. The walls 118, 120, 122, 124 extend vertically from the edges of a top 1040. The hinge 106 is attached to the wall 112, and the wall 124 enables the lid 104 to pivotally move along the hinge 106 and wall 124.

An objective of the storage case 100 of the present invention is that the roasting stick handle can be grasped and accessed when the prongs are stored in the storage case 100. The wall 114 of the main body 102 includes a first semi-circular cut-out 128 and the wall 118 of the lid 104 includes a second semi-circular cut-out 130 such that the first semi-circular cut-out 128 and the second semi-circular cut-out 130 form a circular opening, through which the roasting stick shaft extends out from the case 100.

For latching the main body 102 and the lid 104 to secure and store the prongs of the roasting sticks, the wall 108 of the main body 102 includes a latch base 116 and the wall 120 of the lid 104 includes a latch head 126, such that the latch base 116 and the latch head 126 adhere to each other to close the case 100. The latch base 116 and the latch head 126 can be one of a magnetic fasteners, a snap button, a clip button or the like.

FIG. 1B illustrates a perspective view of the roasting stick prongs storage case of the present invention in a closed condition in accordance with the disclosed architecture. For closing the case 100, the lid 104 is pivotally moved from its opened position as shown in FIG. 1A to cover the main body 102 as shown in the present embodiment. When the lid 104 covers the main body 102, the first semi-circular cut-out 128 and the second semi-circular cut-out 130 form the circular opening through which the roasting stick shaft extends from the case 100. The lid 104 when covered over the main body 102, provides adequate space and protection to the prongs of the roasting stick. The case 100 not only provides a convenient storage and transportation method for roasting sticks enabling the prongs to be safely covered to prevent black char and debris from contaminating a vehicle or the hands, but also protects the prongs from any physical damage. The roasting sticks can be placed in the case 100 and the lid 104 can be shut via the latch for storage and transportation. Further, the handle of the roasting stick remains accessible for convenient grasping of each roasting stick while the prongs are secured within the case 100.

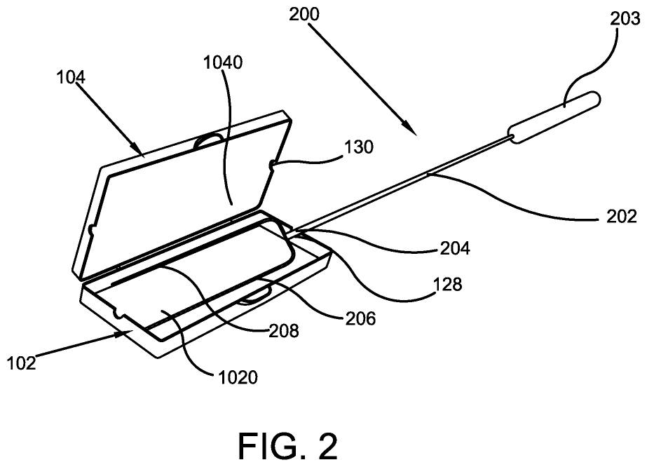

FIG. 2 illustrates a perspective view showing the prongs of an exemplary roasting stick 200 stored in the storage case 100 of the present invention in accordance with the disclosed architecture. The prongs 206, 208 of a conventional roasting stick 200 which is generally used for marshmallows, hot dogs, and other roasting foods can be stored in the storage case 100, and more specifically, can be stored in the main body 102. The main body 102 is dimensioned to accommodate the prongs 206, 208 of at least one roasting stick 200 in a way that the shaft 202 and the connecting portion 204 can extend from the semi-circular cut-outs 128, 130 of the main body 102 and the lid 104, thereby enabling the user to access the handle 203 for easy portability. To store the prongs 206, 208 in the main body 102, the roasting stick 200 is held by a user and the prongs 206, 208 are placed in the main body 102 with the lid 104 positioned in an open position and the shaft 202 is positioned to fit in the semi-circular cut-out 128. It should be appreciated that prongs of a plurality of the roasting sticks can be stored in the storage case 200.

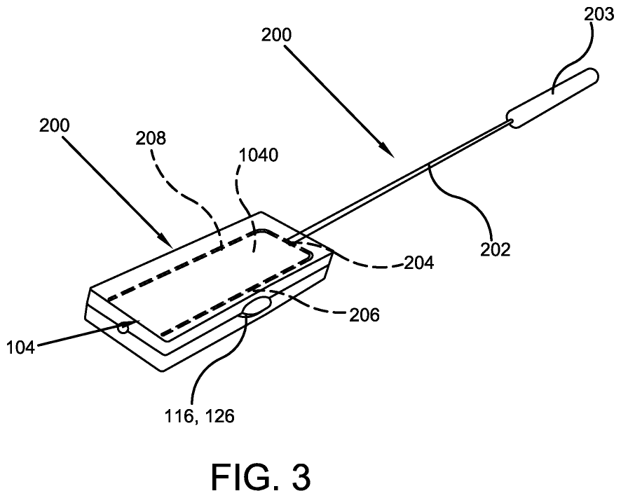

FIG. 3 illustrates a perspective view showing the prongs of the exemplary roasting stick 200 safely covered and shielded in the storage case 100 of the present invention in accordance with the disclosed architecture. To safely cover the prongs 206, 208 to prevent black char and debris from contaminating a vehicle or the hands while storing and transporting the sticks 200 and also for protection from physical damage and injury, the lid 104 can be positioned to cover the main body 102 and can be secured by fastening of the latch head 126 to the latch base 116. When the prongs 206, 208 are safely covered, the shaft 202 can extend from the circular opening formed by the semi-circular cut-outs of both the main body 102 and the lid 104 for easy handling and portability. The prongs 206, 208 remain secured, covered and shielded in the case 100 and even when the roasting stick 200 is held by the handle 203. The prongs 206,208, when enclosed in the case 100, are not exposed and thus dirty, greasy, and sticky prongs are safely stored.

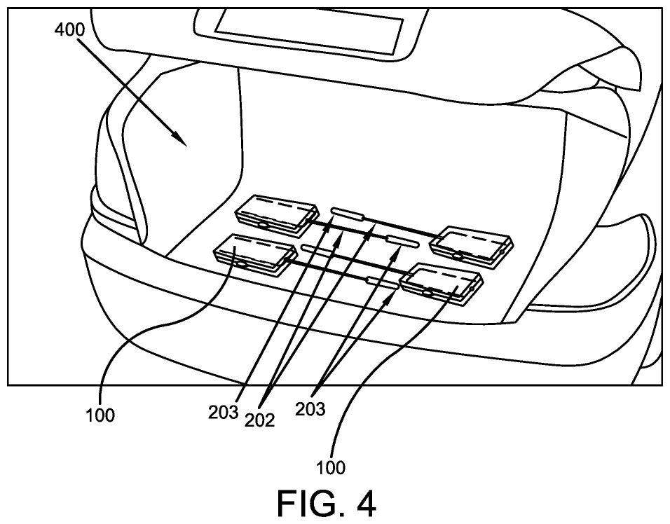

FIG. 4 illustrates a perspective view showing a plurality of roasting sticks stored using protective storage cases 100 of the present invention in a vehicle trunk in accordance with the disclosed architecture. After use of roasting sticks 200 for roasting marshmallows, hot dogs, and other roasting foods, grease and sticky residue can be present on the prongs, which can be hard to clean. The residue can also contaminate the vehicle, clothes and hands of the users. To obviate the aforementioned problems, the prongs can be stored in the storage cases 100. The roasting sticks 200, with the securely stored prongs 206, 208, can be easily kept in the trunk 400 of the vehicle. The prongs 206, 208 are shielded in the case 100 and do not touch the trunk 400 and thereby protect the vehicle from contamination and the users from injury.

The storage case 100 of various embodiments of the present invention can be hard and durable. The cases can come in various sizes and colors and can be waterproof, water-resistant, abrasion resistant, and/or puncture resistant. The latch used for securing the lid and the main body is waterproof, water-resistant, childproof, child resistant, animal proof, and/or animal resistant.

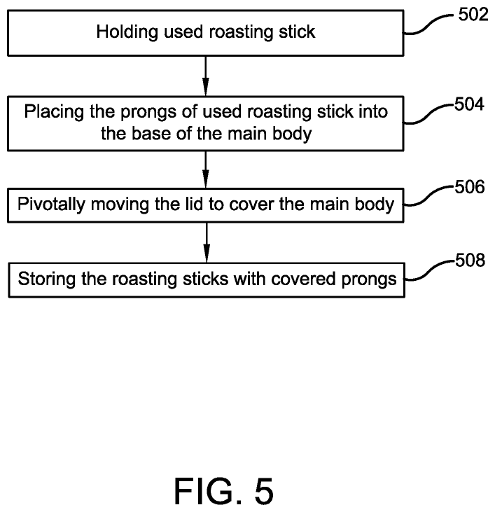

FIG. 5 illustrates a flow chart showing exemplary steps for use of the roasting sticks storage case of the present invention for storing prongs in accordance with the disclosed architecture. Initially, at step 502, the used roasting sticks with sticky and greasy prongs are held by a user. At step 504, the prongs are placed into the base of the main body such that the shaft of the roasting stick fits into a semi-circular cut-out of a wall of the main body. At 506, the lid is pivotally-moved to cover the main body and is secured by fastening the latch head and the latch base to securely store the prongs of the roasting stick. Finally, at step 508, the roasting stick, with the shaft and the handle extending from the storage case and the prongs secured in the case, can be transported without worry of injury and stored in a convenient manner.

Certain terms are used throughout the following description and claim to refer to particular features or components. As one skilled in the art will appreciate, different persons may refer to the same feature or component by different names. This document does not intend to distinguish between components or features that differ in name but not structure or function. As used herein “roasting sticks storage case”, “protective storage case”, “storage case”, “cuboidal protective box”, “roasting stick prongs storage case” and “case”, are interchangeable and refer to the roasting sticks storage case 100 of the present invention.

Notwithstanding the foregoing, the roasting sticks storage case 100 of the present invention can be of any suitable size and configuration as is known in the art without affecting the overall concept of the invention, provided that it accomplishes the above-stated objectives. One of ordinary skill in the art will appreciate that the size, configuration and material of the roasting sticks storage case 100 as shown in the FIGS. are for illustrative purposes only, and that many other sizes and shapes of the roasting sticks storage case 100 are well within the scope of the present disclosure. Although the dimensions of the roasting sticks storage case 100 are important design parameters for user convenience, the roasting sticks storage case 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A storage case for storing prongs of a roasting stick, the storage case comprising:
a main body, wherein said main body receives said prongs therein for storing and shielding said prongs;
a lid, wherein said lid is selectively retained over said main body for covering said prongs, and further wherein said lid is hinged to said main body for pivoting movement of said lid relative to said main body;
wherein said main body comprises four walls extending vertically from a base to create a cavity, and further wherein said cavity surrounds said prongs and said four walls prohibit said prongs from lateral movement therein;
wherein said lid includes a set of four walls extending from a top;
wherein at least one of said four wall of said main body comprises a first semi-circular cut-out and at least one wall of said set of four walls of said lid comprises a second semi-circular cut-out;
wherein said first semi-circular cut-out and said second semi-circular cut-out align to form a circular opening when said lid is retained over said main body; and
further wherein said circular opening provides an aperture for at least one shaft of at least one said roasting stick to extend therethrough.

2. The storage case for storing prongs of a roasting stick of claim 1, wherein said main body includes a latch base and said lid includes a latch head for securing said main body to said lid.

3. The storage case for storing prongs of a roasting stick of claim 2, wherein said latch base and said latch head are selected from a group consisting of a plurality of magnetic fasteners, a plurality of snap buttons and a plurality of clip buttons.

4. The storage case for storing prongs of a roasting stick of claim 3, wherein said roasting stick includes a handle at a terminal end of said shaft for grasping and transporting said case and said roasting stick.

5. The storage case for storing prongs of a roasting stick of claim 4, wherein said main body is rectilinear.

6. The storage case for storing prongs of a roasting stick of claim 5, wherein said circular opening provides an aperture for at least two shafts of at least two said roasting sticks to extend therethrough.

7. The storage case for storing prongs of a roasting stick of claim 6, wherein said main body and said lid form a cuboidal said storage case.

8. A storage case for storing prongs of a roasting stick, the storage case comprising:
a main body comprising four walls extending vertically from a base to create a cavity, wherein said cavity surrounds said prongs and said four walls prohibit said prongs from lateral movement therein;
a lid comprising a set of four walls extending from a top, wherein said lid is selectively retained over said main body for covering said prongs, and further wherein said lid is hinged to said main body for pivoting movement of said lid relative to said main body;
wherein at least one wall of said four walls of said main body comprises a first semi-circular cut-out and at least one wall of said set of four walls of said lid comprises a second semi-circular cut-out, and further wherein said first semi-circular cut-out and said second semi-circular cut-out align to form a circular opening when said lid is retained over said main body;
wherein said circular opening provides an aperture for a shaft of said roasting stick to extend therethrough;
wherein said main body is rectilinear; and
further wherein said roasting stick comprises a handle at a terminal end of said shaft for grasping and transporting said case and said roasting stick.

9. The storage case for storing prongs of a roasting stick of claim 8, wherein said main body comprises a latch base and said lid includes a latch head for securing said main body to said lid.

10. The storage case for storing prongs of a roasting stick of claim 9, wherein said latch base and said latch head are selected from a group consisting of a magnetic fastener, a snap button and a clip button.

11. The storage case for storing prongs of a roasting stick of claim 10, wherein said circular opening provides an aperture for at least two shafts of at least two roasting sticks to extend therethrough.

12. The storage case for storing prongs of a roasting stick of claim 11, wherein said main body and said lid form a cuboidal storage case.

13. A storage case for storing prongs of a roasting stick, the storage case comprising:
a main body comprising four walls extending vertically from a base to create a cavity, wherein said cavity surrounds said prongs and said four walls prohibit said prongs from lateral movement therein;
a lid comprising a set of four walls extending from a top, wherein the lid is hinged to said main body for pivoting movement of said lid relative to said main body;
wherein at least one of said four walls of the main body includes a first cut-out that forms an opening when said lid is retained over said main body; and
further wherein said opening provides an aperture for a shaft of said roasting stick to extend therethrough.

14. The storage case for storing prongs of a roasting stick of claim 13, wherein said main body is rectilinear.

15. The storage case for storing prongs of a roasting stick of claim 13, wherein said at least one said roasting stick includes a handle at a terminal end of said at least one shaft for grasping and transporting said case and said at least one said roasting stick.

16. The storage case for storing prongs of a roasting stick of claim 13, wherein at least one wall of said lid includes a second cut-out; and further wherein said first cut-out and said second cut-out aligned to form said opening.

17. The storage case for storing prongs of a roasting stick of claim 15, wherein said main body includes a latch base and said lid includes a latch head for securing said main body to said lid.

18. The storage case for storing prongs of a roasting stick of claim 17, wherein said latch base and said latch head are selected from a group consisting of magnetic fasteners, snap buttons, and clip buttons.

19. The storage case for storing prongs of a roasting stick of claim 13, wherein said opening provides an aperture for at least two shafts of at least two said roasting sticks to extend therethrough.

20. The storage case for storing prongs of a roasting stick of claim 13, wherein said main body and said lid form a cuboidal said storage case.
